(19) United States
(12) Patent Application Publication
(10) Pub. No.: US 2025/0074792 A1
(43) Pub. Date: Mar. 6, 2025

(54) WATER SOFTENER

(71) Applicant: GREEN BRUSH LTD., Bnei Shimon Regional Council (IL)

(72) Inventors: Adam GILADI, Bnei Shimon Regional Council (IL); Zohar Bar SINAY, Bnei Shimon Regional Council (IL)

(21) Appl. No.: 18/817,569

(22) Filed: Aug. 28, 2024

Related U.S. Application Data
(60) Provisional application No. 63/535,746, filed on Aug. 31, 2023.

(51) Int. Cl. C02F 1/42; A46B 9/06; A46B 11/00; A46B 11/06; C02F 1/28; H02S 40/10

(52) U.S. Cl. CPC C02F 1/42; A46B 9/06; A46B 11/0082; A46B 11/063; C02F 1/288; H02S 40/10; A46B 2200/3073; C02F 2201/002; C02F 2307/00

(57) ABSTRACT

A water softener is disclosed. The water softener comprising: an elongated body defining an internal space configured to hold a water softening medium; the elongated body comprising: a water inlet; a water outlet; and at least two spacers, each positioned in proximity to a different end of the elongated body and configured to distance the elongated body from a support surface. In some embodiments, the water inlet and water outlet are at opposite ends of the elongated body. In some embodiments, the diameter of the water inlet is larger than the diameter of the water outlet.

### CROSS REFERENCE TO RELATED APPLICATIONS

This application claims the benefit of priority of U.S. Provisional Patent Application No. 63/535,746, filed Aug. 31, 2023, the contents of which are all incorporated herein by reference in their entirety.

### FIELD OF THE INVENTION

The present invention relates generally to water softeners. More specifically, the present invention relates to water softener for the use in cleaning solar panels.

### BACKGROUND OF THE INVENTION

Solar panels work most efficiently when they are clean of dust and sediment. Regular tap water is likely to contain high concentrations of calcium and magnesium. If such water is used for cleaning solar panels, scale/limescale forms on the panels when the water dries. Chemicals or compounds used to dissolve scales also irreversibly damage the special coating of the panels. As such, scale-causing molecules must be removed from cleaning water prior to usage.

Cleaning domestic solar panel systems is done manually by a dedicated spraying and brushing systems. These systems must utilize softened water otherwise, the spraying nozzles or brushes can be blocked by scale/limescale.

Currently use industrial softening devices are too large too heavy for the use in domestic solar panel systems. Therefore, these middle-size (e.g., domestic) softening devices are used for domestic solar panel systems. These middle-size softening systems lack the ability to control the effectiveness of water softening. In these middle-size softening systems it is impossible to track when the softening is no longer effective.

Therefore, there is a need for a simple water softener that is suitable for the use in solar panel fields, that also endures the elevated temperatures in the field with no to little reduction in softening efficiency.

### SUMMARY OF THE INVENTION

Some aspects of the invention may be directed to a water softener comprising: an elongated body defining an internal space configured to hold a water softening medium; the elongated body comprising: a water inlet; a water outlet; and at least two spacers, each positioned in proximity to a different end of the elongated body and configured to distance the elongated body from a support surface. In some embodiments, the water inlet and water outlet are at opposite ends of the elongated body. In some embodiments, the diameter of the water inlet is larger than the diameter of the water outlet.

In some embodiments, a ratio between the diameter of the water inlet and the diameter of the water outlet is at least 1.2. In some embodiments, the elongated body has a cross-section A of between 2500 to 3000 mm². In some embodiments, the distance of the elongated body from a support surface is between 10 to 20 mm. In some embodiments, the water inlet comprises a first quick-release connector to be connected to a water supply system.

In some embodiments, the water outlet comprises a second quick-release connector to be connected to a cleaning tool. In some embodiments, the cleaning tool is a brush and wherein the second quick-release connector is connectable to an inner tube in a pole of the brush. In some embodiments, the second quick-release connector is connectable to the inner tube via a flexible pipe.

In some embodiments, at least one spacer a detachably connected to the elongated body, thereby allowing the replacement of the softening medium. In some embodiments, the water softener further comprises at least one filter preceding the water outlet, to prevent discharge of softening medium from the water softener.

In some embodiments, the elongated body is cylindrical. In some embodiments, the elongated body is made of at least two identical interconnectable parts connectable by at least one grooved connecting ring. In some embodiments, the at least two spacers are radial protrusions extending outwardly from an outer wall of the elongated body.

Some additional aspects of the invention may be related to a water softener for solar panels, comprising: an elongated body defining an internal space; a water softening medium held inside the internal space. In some embodiments, the elongated body comprising: a water inlet; and a water outlet. In some embodiments, the water softening medium comprising: a polymeric resin; and between 1.2 to 4 wt. % activated carbon bituminous.

In some embodiments, the activated carbon bituminous is an activated carbon bituminous having iodine number larger than 750 mg/g. In some embodiments, the activated carbon bituminous has particle size of 8×30 MESH. In some embodiments, the polymeric resin comprises polypropylene copolymer.

In some embodiments, the water softener further comprises at least two spacers, each positioned in proximity to a different end of the elongated body and configured to distance the elongated body from a support surface. In some embodiments, the water inlet and water outlet are at opposite ends of the elongated body. In some embodiments, the diameter of the water inlet is larger than the diameter of the water outlet. In some embodiments, a ratio between the diameter of the water inlet and the diameter of the water outlet is at least 1.2. In some embodiments, the elongated body has a cross-section A of between 2500 to 3000 mm². In some embodiments, the distance of the elongated body from a support surface is between 10 to 20 mm.

Some additional aspects of the invention may be related to a kit for cleaning solar panels, the kit comprising: a water softener according to any embodiments disclosed herein; and a brush, wherein the brush comprises: a pole, having an outer wall and an inner tube; a brush head, having a plurality of groups of bristles; and a water splitter, fluidly connected from one side to the inner tube, and from another side to at least two of the plurality of groups of bristles.

In some embodiments, the water splitter is configured to direct softened water from the water softener, via the inner tube in the pole, to the at least two of the plurality of groups of bristles in the brush head.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A includes illustrations of front and side views of a water softener according to some embodiments of the invention;

FIG. 1B is an illustration of a cross section view of a water softener according to some embodiments of the invention; and

FIG. 2 is an illustration of a kit according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Some aspects of the invention are directed to a water softener suitable for providing soft water to solar panel cleaning devices in domestic solar panel systems. The softener can be easily connected to a water supply system and to a brush configured to clean the solar panels.

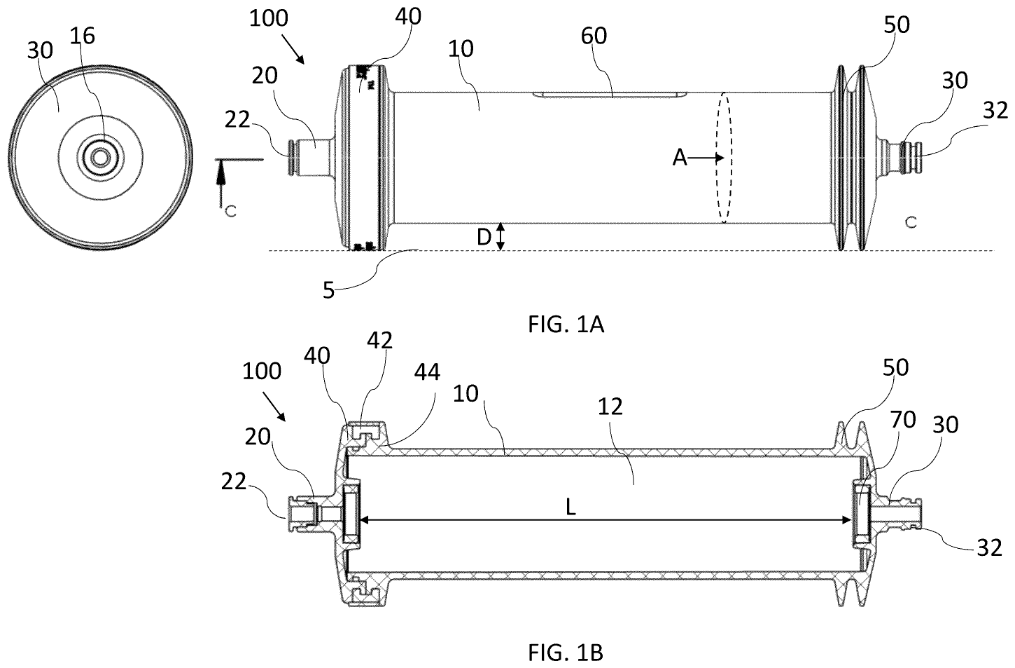

Reference is now made to FIGS. 1A and 1B which are illustrations of front, side, and cross section views of a water softener according to some embodiments of the invention. A water softener 100 may include an elongated body 10 defining an internal space 12 configured to hold a water softening medium. In some embodiments, elongated body 10 may include a water inlet 20, a water outlet 30, and at least two spacers 40 and 50, each positioned in proximity to a different end of elongated body 10. In some embodiments, water inlet 20 and water outlet 30 are at opposite ends of the elongated body 10. In some embodiments, elongated body 10 is cylindrical. In some embodiments, elongated body 10 has an ellipsoid cross-section, a rectangular cross-section, a hexagonal cross-section, and the like.

In some embodiments, a diameter of water inlet 20 is larger than the diameter of water outlet 30. Therefore, a pressure may be built at outlet 30 forcing the water to fill internal space 12 prior to exiting from outlet 30. In some embodiments, a ratio between the diameter of water inlet 20 and the diameter of water outlet 30 is at least 1.1, for example, at least 1.2, at least 1.3, at least 1.35, at least 1.4, at least 1.5, at least 2, and any value in between. In some embodiments, elongated body 10 has a length L of between 200 to 600 mm and a cross-section A of between 2500 to 3000 mm², for example, between 2600 mm² to 2700 mm², between 2650 to 2800 mm², between 2750 to 2850 mm², between 2800 to 2900 mm², between 2850 to 300 mm², and any value or range in between. In some embodiments, the ratio between the diameter of water inlet 20 and the diameter of water outlet 30 is also determined based on L and A.

In a nonlimiting example, the diameter of inlet 20 is 6 mm and the dimeter of outlet 30 is 8 mm. In such nonlimiting example, the wall thickness of elongated body 10 is 4 mm.

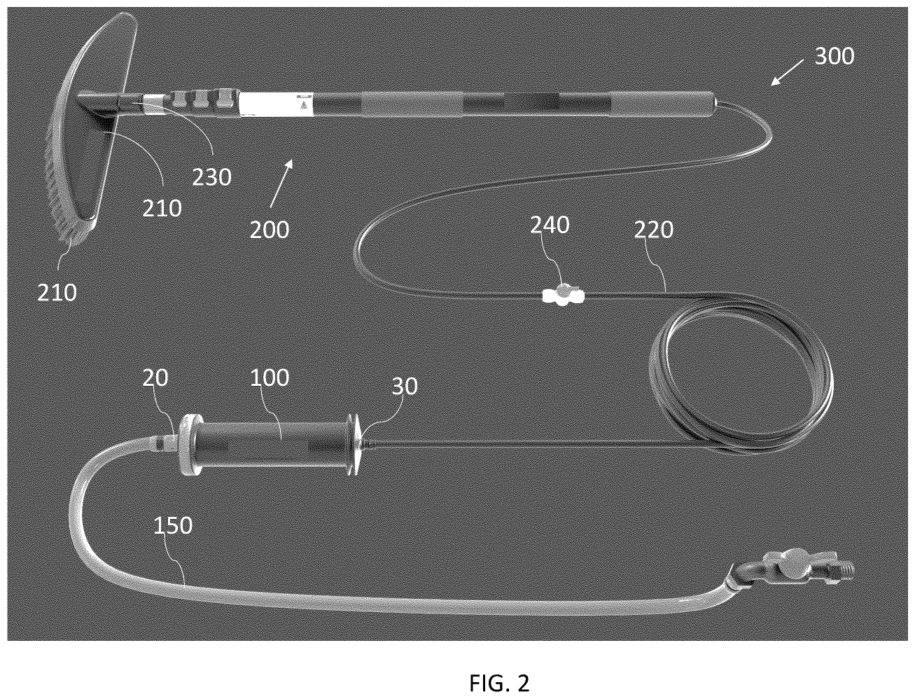

In some embodiments, water inlet 20 comprises a first quick-release connector to be connected to a water supply system 150, illustrated in FIG. 2. In some embodiments, water outlet 30 comprises a second quick-release connector to be connected to a cleaning tool 200, illustrated in FIG. 2 In some embodiments, the cleaning tool is a brush and the second quick-release connector is connectable to an inner tube in a pole of the brush. In some embodiments, the second quick-release connector is connectable to the inner tube via a flexible pipe.

In some embodiments, at least two spacers 40 and 50 are configured to distance, at a distance D of between 10 to 20 mm, elongated body 10 from a support surface 5, thereby distancing the softening medium inside space 12 from the surface. In some embodiments, the distance D may be 11 mm, 12 mm, 12.5 mm, 13 mm, 13.5 mm, 14 mm, 14.5 mm, 15 mm, 16 mm, 17 mm, 18 mm, 19 mm, or any value in between. In the nonlimiting example where water softener is placed on the ground in domestic solar panel system, the soil/ground tends to heat to elevated temperatures that may exceed 40 degrees. These elevated temperatures may reduce the softening efficiency of the softening medium. Accordingly, spacing elongated body 10 from surface 5 by at least 10 mm may ensure keeping the temperature of the water/medium in space 12 below 60° C. In some embodiments, water softener 100 may held water at a pressure of up to 4 bar.

In some embodiments, at least one spacer 50 may be an integral part of elongated body 10, as illustrated. In some embodiments, at least one spacer 40 may be detachably connected (e.g., via connector 42) to elongated body 10, as illustrated. In some embodiments, detachably connected spacer 40 may allow access to space 12 and the replacement of the softening medium. In some embodiments, at least two spacers 50 are radial protrusions extending outwardly from an outer wall of the elongated body.

In some embodiments, elongated body 10 is made of at least two identical interconnectable parts connectable by at least one grooved connecting ring, not illustrated. Such an assembly may also allow the replacement of the softening medium.

In some embodiments, the softening medium may include any material capable of deionizing and softening water. Some nonlimiting examples for softening medium may include ion-exchange resin or ion-exchange polymer is a resin or polymer that acts as a medium for ion exchange, for example, small (0.25-1.43 mm radius) polystyrene sulfonate microbeads. The beads are typically porous, providing a large surface area on and inside them where the trapping of ions occurs along with the accompanying release of other ions.

In some embodiments, the softening medium may include a polymeric resin; and between 1 to 5 wt. % activated carbon bituminous. For example, the softening medium may include between 1.2 to 4 wt. % activated carbon bituminous, between 1.2 to 4.5 wt. % activated carbon bituminous, between 1.5 to 4 wt. % activated carbon bituminous, between 2 to 3.5 wt. % activated carbon bituminous, between 2.5 to 5 wt. % activated carbon bituminous, and any value or range in between.

In some embodiments, the activated carbon bituminous is an activated carbon bituminous having iodine number larger than 750 mg/g. In some embodiments, the activated carbon bituminous has a particle size of 8×30 MESH.

In some embodiments, the polymeric resin may include a polypropylene copolymer or any other suitable polymeric resin.

In some embodiments, water softener may further include at least one filter 70 preceding water outlet 30, to prevent discharge of softening medium from water softener 100.

In some embodiments, elongated body 10 may include a window/screen 60 for indicating the state of the softening medium. Window 60 may simply allow visual monitoring the state (e.g., color, texture, and the like) of the state of the softening medium.

In some embodiments, window/screen 60 may be an electrical display in communication with a controller and at least one sensor capable of measuring a property indicative of the state of the softening medium. In such case, at least one of window/screen 60, the controller, and the sensor may all be connected to an electrical power source (e.g., a battery). Some nonlimiting examples for sensors may include, a flowmeter, a pH sensor, a pressure sensor, a thermometer, and the like. Some nonlimiting examples for signals indicative of the state of the softening medium may include, a reduction in flow rate due to scaling, change in the pH of water, increase in temperature, increase in pressure and the like.

In some embodiments, if the signal is above or below a predetermined threshold value, the controller may display an alert on screen 60 and/or send the alert to a user device (e.g., a mobile phone).

Some additional aspects of the invention may be directed to a kit for cleaning solar panels. The kit may include water softener 100 and a brush. Reference is now made to FIG. 2 which is an illustration of a kit according to some embodiments of the invention. A kit 300 may include a brush 200 and water softener 100.

In some embodiments, brush 200 may include a pole 220, having an outer wall and an inner tube, a brush head 210, having a plurality of groups of bristles 215 (e.g., 200 or more) and a water splitter 230, fluidly connected from one side to the inner tube, and from another side to at least two of the plurality of groups 215 of bristles. In some embodiments, water splitter 230 is configured to direct softened water from water softener 100, via the inner tube in pole 220, to the at least two of the plurality of groups 215 of bristles in brush head 210.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A water softener comprising:
an elongated body defining an internal space configured to hold a water softening medium;
the elongated body comprising:
a water inlet;
a water outlet; and
at least two spacers, each positioned in proximity to a different end of the elongated body and configured to distance the elongated body from a support surface,
wherein the water inlet and water outlet are at opposite ends of the elongated body, and
wherein the diameter of the water inlet is larger than the diameter of the water outlet.

2. The water softener of claim 1 wherein a ratio between the diameter of the water inlet and the diameter of the water outlet is at least 1.2.

3. The water softener of claim 1, wherein the elongated body has a cross-section A of between 2500 to 3000 mm².

4. The water softener of claim 1, wherein the distance of the elongated body from a support surface is between 10 to 20 mm.

5. The water softener of claim 1, wherein at least one spacer a detachably connected to the elongated body, thereby allowing the replacement of the softening medium.

6. The water softener of claim 1, further comprising at least one filter preceding the water outlet, to prevent discharge of softening medium from the water softener.

7. The water softener of claim 1, wherein the elongated body is made of at least two identical interconnectable parts connectable by at least one grooved connecting ring.

8. The water softener of claim 1, wherein the at least two spacers are radial protrusions extending outwardly from an outer wall of the elongated body.

9. A water softener for solar panels, comprising:
an elongated body defining an internal space;
a water softening medium held inside the internal space,
wherein the elongated body comprising:
a water inlet; and
a water outlet,
and wherein the water softening medium comprising:
a polymeric resin; and
between 1.2 to 4 wt. % activated carbon bituminous.

10. The water softener of claim 9, wherein the activated carbon bituminous is an activated carbon bituminous having iodine number larger than 750 mg/g.

11. The water softener of claim 9, wherein the activated carbon bituminous has particle size of 8×30 MESH.

12. The water softener of claim 9, wherein the polymeric resin comprises polypropylene copolymer.

13. The water softener of claim 9, further comprising at least two spacers, each positioned in proximity to a different end of the elongated body and configured to distance the elongated body from a support surface.

14. The water softener of claim 9,
wherein the water inlet and water outlet are at opposite ends of the elongated body, and
wherein the diameter of the water inlet is larger than the diameter of the water outlet.

15. The water softener of claim 9, wherein a ratio between the diameter of the water inlet and the diameter of the water outlet is at least 1.2.

16. The water softener according to claim 14, wherein the elongated body has a cross-section A of between 2500 to 3000 mm².

17. The water softener of claim 9, wherein the distance of the elongated body from a support surface is between 10 to 20 mm.

18. A kit for cleaning solar panels, the kit comprising:
a water softener according to claim 1; and
a brush, wherein the brush comprises:
a pole, having an outer wall and an inner tube;
a brush head, having a plurality of groups of bristles; and
a water splitter, fluidly connected from one side to the inner tube, and from another side to at least two of the plurality of groups of bristles.

19. The kit according to claim 18, wherein the water splitter is configured to direct softened water from the water softener, via the inner tube in the pole, to the at least two of the plurality of groups of bristles in the brush head.
